(19) United States
(12) Patent Application Publication
(10) Pub. No.: US 2007/0231002 A1
(43) Pub. Date: Oct. 4, 2007

(54) TRANSFER ROLLER CONTACT AND SEPARATION DRIVE UNIT AND TRANSFER ROLLER CONTACT AND SEPARATION DRIVE METHOD

(75) Inventor: Norio Kouzu, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/694,581

(22) Filed: Mar. 30, 2007

(30) Foreign Application Priority Data
Mar. 30, 2006 (JP) 2006-093048

(51) Int. Cl. G03G 15/16

(52) U.S. Cl. 399/121; 399/313

(57) ABSTRACT

There is provided, in a secondary transfer section including a mechanism for bringing a transfer roller into contact with an image carrier and separating it from the image carrier, a transfer roller contact and separation drive unit that does not increase the number of parts in a section that constituting a mechanism for operating contact and separation operation and does not use a device such as an electromagnetic clutch that requires electrical control.

A transfer roller contact and separation drive unit that moves a transfer roller for pressing a sheet against an image carrier carrying a toner image between a first position at which the transfer roller is brought into contact with the image carrier and a second position at which the transfer roller is separated from the image carrier, comprises: a contact and separation mechanism that supports the transfer roller such that the transfer roller can move between the first and second positions; a motor that can be rotated in both normal and reverse directions; a first one-way clutch that transfers the driving power of the motor to a predetermined roller for performing sheet feed operation as a rotation driving power only when the motor is rotated in a first direction; and a second one-way clutch that transfers the driving power of the motor to the contact and separation mechanism so as to move the transfer roller between the first and second positions only when the motor is rotated in a second direction opposite to the first direction.

### BACKGROUND OF THE INVENTION

1. Field of the Invention

The present invention relates to a transfer roller contact and separation drive unit having a contact and separation mechanism that brings a transfer roller into contact with an image carrier when a toner image formed on the image carrier is transferred onto a sheet while separate the transfer roller from the image carrier when a toner image is not transferred onto a sheet.

2. Description of the Related Art

A conventional transfer unit has a contact and separation mechanism that brings a transfer roller into contact with an image carrier when a toner image formed on the image carrier is transferred onto a sheet while separate the transfer roller from the image carrier when a toner image is not transferred onto a sheet. There is available, as a drive source for performing the contact and separation operation of the transfer roller, a mechanism that obtains a motive force from a motor drive train of a sheet feed system or image forming system and a mechanism which includes a dedicated drive source for performing the contact and separation operation on the transfer roller.

As the mechanism that obtains a motive force from a motor drive train of a sheet feed system or image forming system, there is proposed a configuration in which one transfer drive roller of a resist roller pair serves also as a roller for driving a transfer belt of a transfer unit (refer to. e.g., Jpn. Pat. Appln. Laid-Open Publication No. 2000-162900).

As another mechanism, there is proposed a configuration in which a resist roller is pivotally fitted to a transfer unit, a pressurized frame is pivotally fitted to the shaft of a drive gear at the position near the resist roller, a resist roller gear and a transfer roller gear are engaged with the drive gear, and a one-way clutch is provided in the resist roller gear (refer to. e.g., Jpn. Pat. Appln. Laid-Open Publication No. 6-130828).

However, in the conventional transfer roller contact and separation drive unit, the mechanism that obtains a motive force from a motor drive train of a sheet feed system or image forming system is subject to restriction of operating time due to influence of the speed of a drive system serving as a drive source as well as requires a control mechanism using an electromagnetic clutch for controlling the contact and separation operation.

Further, in the mechanism which includes a dedicated drive source for performing the contact and separation operation on the transfer roller, a use of the dedicated drive source for the contact and separation operation increases the number of parts in the mechanism, leading to an increase in power consumption.

### SUMMARY OF THE INVENTION

An object of an embodiment of the present invention is to provide, in a secondary transfer section including a mechanism for bringing a transfer roller into contact with an image carrier and separating it from the image carrier, a transfer roller contact and separation drive unit that does not increase the number of parts in a section that constitutes a mechanism for operating contact and separation operation and does not use a device such as an electromagnetic clutch that requires electrical control.

To solve the above problems, according to a first aspect of the present invention, there is provided a transfer roller contact and separation drive unit that moves a transfer roller for pressing a sheet against an image carrier carrying a toner image between a first position at which the transfer roller is brought into contact with the image carrier and a second position at which the transfer roller is separated from the image carrier, comprising: a contact and separation mechanism that supports the transfer roller such that the transfer roller can move between the first and second positions; a motor that can be rotated in both normal and reverse directions; a first one-way clutch that transfers the driving power of the motor to a predetermined roller for performing sheet feed operation as a rotation driving power only when the motor is rotated in a first direction; and a second one-way clutch that transfers the driving power of the motor to the contact and separation mechanism so as to move the transfer roller between the first and second positions only when the motor is rotated in a second direction opposite to the first direction.

According to a second aspect of the present invention, there is provided an image forming apparatus comprising: a transfer roller contact and separation drive unit having the above configuration and a fixing unit that thermally fixes the toner image onto a sheet that has been subjected to an image transfer process by being pressed against the image carrier by means of the transfer roller.

According to a third aspect of the present invention, there is provided a transfer roller contact and separation drive unit that moves a transfer roller for pressing a sheet against an image carrier carrying a toner image between a first position at which the transfer roller is brought into contact with the image carrier and a second position at which the transfer roller is separated from the image carrier, comprising: a contact and separation means for supporting the transfer roller such that the transfer roller can move between the first and second positions; a motor that can be rotated in both normal and reverse directions; a first driving power transfer means for transferring the driving power of the motor to a predetermined roller for performing sheet feed operation as a rotation driving power only when the motor is rotated in a first direction; and second driving power transfer means for transferring the driving power of the motor to the contact and separation means so as to move the transfer roller between the first and second positions only when the motor is rotated in a second direction opposite to the first direction.

According to a fourth aspect of the present invention, there is provided an image forming apparatus comprising: a transfer roller contact and separation drive unit having the above configuration and a fixing means for thermally fixing the toner image onto a sheet that has been subjected to an image transfer process by being pressed against the image carrier by means of the transfer roller.

According to a fifth aspect of the present invention, there is provided a transfer roller contact and separation drive method that moves a transfer roller for pressing a sheet against an image carrier carrying a toner image between a first position at which the transfer roller is brought into contact with the image carrier and a second position at which the transfer roller is separated from the image carrier, comprising: transferring the driving power of the motor to a predetermined roller for performing sheet feed operation using a first one-way clutch as a rotation driving power only when the motor is rotated in a first direction; and transferring the driving power of the motor to the contact and separation mechanism that supports the transfer roller such that the transfer roller can move between the first and second positions using a second one-way clutch so as to move the transfer roller between the first and second positions only when the motor is rotated in a second direction opposite to the first direction.

### BRIEF DESCRIPTION OF THE DRAWINGS

FIG. 1 is a perspective view showing a configuration of a transfer roller contact and separation drive unit according to an embodiment of the present invention;

FIG. 2 is a view schematically showing a configuration of an image forming section of an image forming apparatus provided with the transfer roller contact and separation drive unit according to the present embodiment;

FIG. 3 is a side view of the transfer roller contact and separation drive unit; and

FIG. 4 is a front view showing a gear configuration in the transfer roller contact and separation drive unit according to the present embodiment.

### DESCRIPTION OF THE PREFERRED EMBODIMENTS

An embodiment of the present invention will be described below with reference to the accompanying drawings.

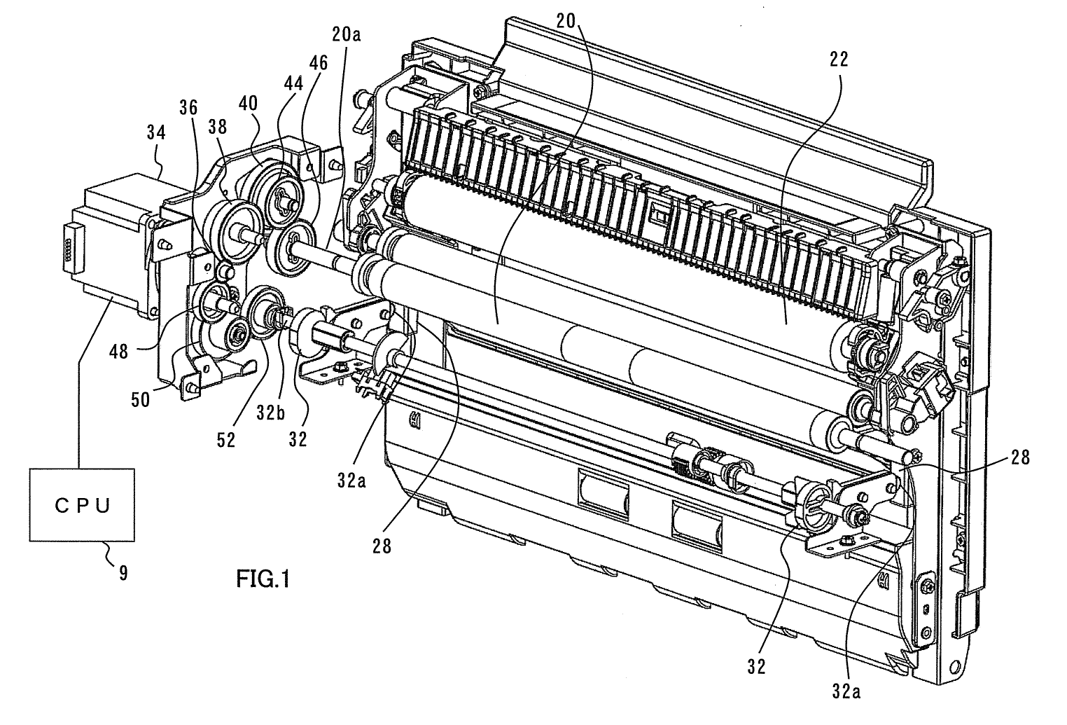

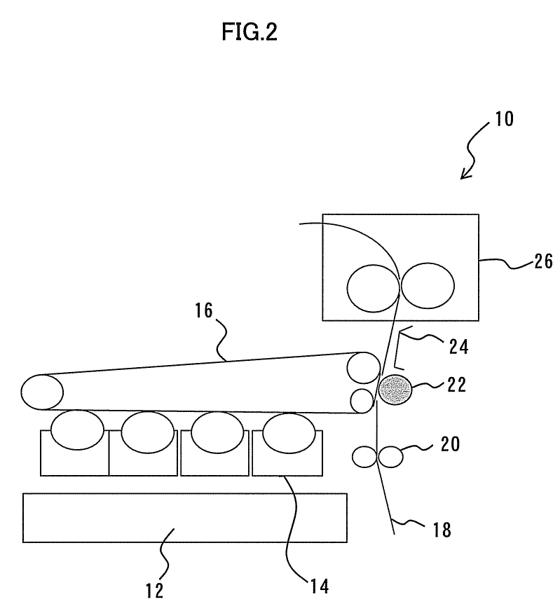

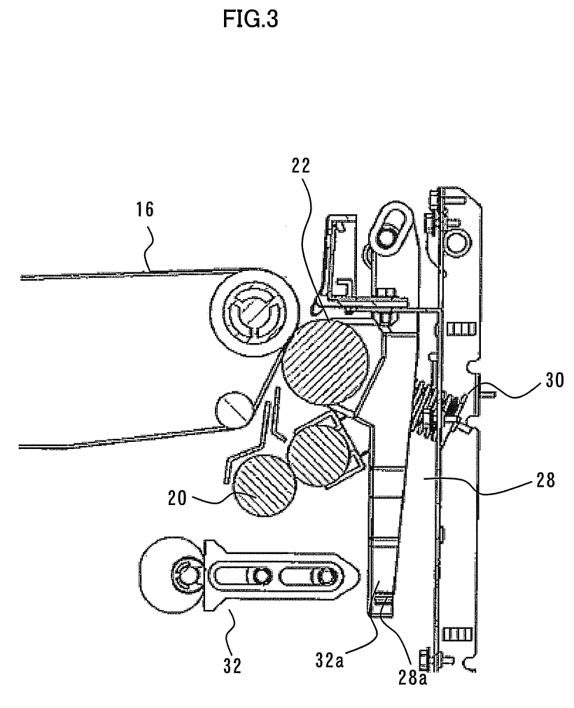

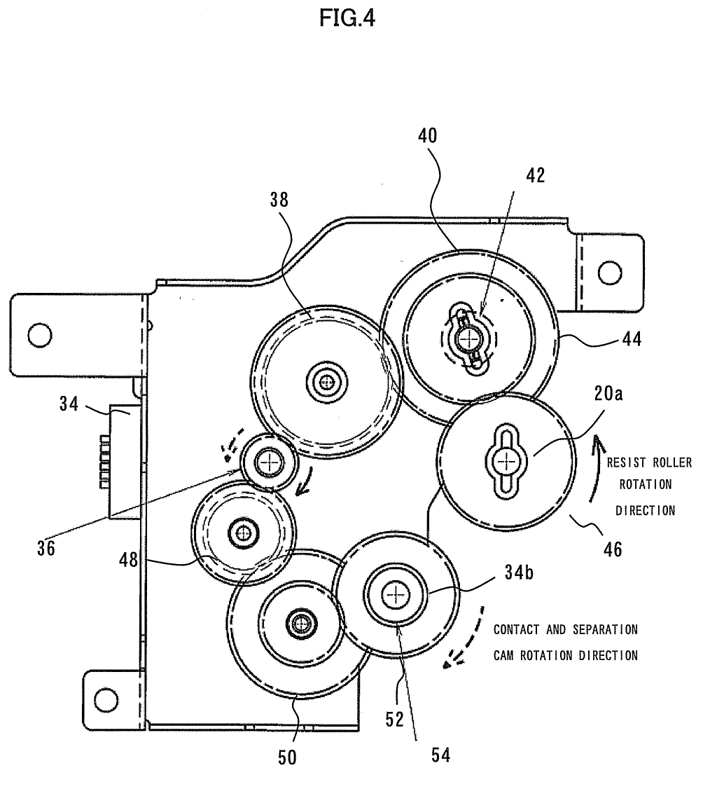

FIG. 1 is a perspective view showing a configuration of a transfer roller contact and separation drive unit according to an embodiment of the present invention, FIG. 2 is a view schematically showing a configuration of an image forming section of an image forming apparatus provided with the transfer roller contact and separation drive unit according to the present embodiment, FIG. 3 is a side view of the transfer roller contact and separation drive unit, and FIG. 4 is a front view showing a gear configuration in the transfer roller contact and separation drive unit according to the present embodiment. The transfer roller contact and separation drive unit according to the present embodiment has a role of moving a transfer roller for pressing a sheet against an image carrier that carries a toner image between a first position at which the transfer roller is brought into contact with the image carrier and a second position at which the transfer roller separates from the image carrier.

As shown in FIG. 2, the image forming section 10 includes a laser unit 12, a developing unit 14, a transfer belt (image carrier) 16, a sheet feed path 18, a resist roller 20, a secondary transfer roller (transfer roller) 22, a feed guide 24, and a fixing unit (fixing section, fixing means) 26. The laser unit 12, developing unit 14 and transfer belt 16 constitute an image forming system. The resist roller (predetermined roller) 20 and fixing unit 26 constitute a sheet feed system.

The laser unit 12 irradiates the developing unit 14 with a laser beam light-modulated according to an image signal of a document scanned in a not-shown scanner section or image signal input from an external device to thereby form an electrostatic latent image thereon. The developing unit 14 performs reversal development of the electrostatic latent image to transfer a toner image onto the transfer belt 16.

The sheet feed path 18 is a feed path of a sheet supplied from a not-shown sheet supply section, and the resist roller 20 corrects the tilt of a sheet immediately before being subjected to image transfer. The secondary transfer roller 22, which is so disposed as to be brought into contact with the transfer belt 16 disposed on the downstream side relative to the resist roller 20, transfers a toner image onto a sheet passing between the secondary transfer roller 22 and transfer belt 16 at once. The feed guide 24 guides a sheet discharged from the secondary transfer roller 22 to the fixing unit 26, and the fixing unit 26 fixes the image that has been transferred by the secondary transfer roller 22 onto the sheet.

Next, details of the transfer roller contact and separation drive unit will be described.

As shown in FIGS. 1, 3, and 4, the both ends of secondary transfer roller 22 are rotatably supported by a pair of lever-like members (contact and separation mechanism, contact and separation means) 28 so to be movable between first and second positions. Each of the lever-like members 28 can freely swing with substantially the center position in the longitudinal direction thereof as a supporting point. Each lever-like member 28 is always biased by an elastic force of a spring 30 at the supporting point to a direction in which the secondary transfer roller 22 is brought into contact with the transfer belt 16. A contact and separation cam 32 is provided near a lower end portion 28a of each lever-like member 28. When a leading end 32a of the contact and separation cam 32 presses the lower end portion 28a of the lever-like member 28, the lever-like member 28 swings against the elastic force of the spring 30 to allow the secondary transfer roller 22 to separate from the transfer belt 16 (second position). On the other hand, when the leading end 32a of the contact and separation cam 32 separates from the lever-like member 28, the lever-like member 28 swings to a position at which the secondary transfer roller 22 is brought into contact with the transfer belt 16 by an elastic force of the spring 30 (first position).

Each contact and separation cam 32 is driven by a pulse-driven stepping motor (motor) 34 which can rotate the resist roller 20 in forward and backward directions. To the resist roller 20, only a driving power at the time of normal rotation (direction of a solid-line arrow in FIG. 4) of the stepping motor 34 is transferred; while to the contact and separation cam 32, only a driving power at the time of reverse rotation (direction of a broken-line arrow in FIG. 4) of the stepping motor 34 is transferred. The drive speed of the stepping motor 34 can be switched between three levels (low-speed: 75 mm/sec, middle-speed: 150 mm/sec, high-speed: 200 mm/sec). The drive of the stepping motor 34 is performed under a CPU (motor controller, motor control means) 9. The CPU 9 drives the stepping motor 34 such that the rotation speed at the time when the stepping motor 34 is rotated in a first direction (rotation direction of the solid-line arrow in FIG. 4) and that at the time when the stepping motor 34 is rotated in a second direction (rotation direction of the broken-line arrow in FIG. 4) differ from each other.

Next, with reference to FIG. 4, a driving power transfer mechanism from the stepping motor 34 to resist roller 20 and the contact and separation cam 32 will be described. The driving power transfer mechanism from the stepping motor 34 to the resist roller 20 will be first described. A motor gear 36 of the stepping motor 34 is engaged with a first gear 38 so as to transfer the rotation thereof, and the first gear 38 is engaged with a second gear 40 so as to transfer the rotation thereof. The rotation of the second gear 40 is transferred to a third gear 44 through a first one-way clutch 42 (first driving power transfer means). The first one-way clutch 42 couples the second gear 40 and the third gear 44 only when the motor gear 36 is rotated in the normal direction (direction of the solid-line arrow in FIG. 4) to transfer the rotation of the second gear 40 to the third gear 44, while it runs idle when the motor gear 36 is rotated in the reverse direction (direction of the broken-line arrow in FIG. 4), so that the rotation of the second gear 40 is not transferred to the third gear 44. The third gear 44 is engaged with a resist roller gear 46 which is coupled to a rotary shaft 20a of the resist roller 20 so as to be integrally rotated to thereby transfer a driving power to the resist roller 20. In this manner, only when the motor is rotated in the first direction, the first one-way clutch 42 transfers a driving power of the motor to a predetermined roller that performs sheet feed operation as a rotation driving power.

The driving power transfer mechanism from the stepping motor 34 to the contact and separation cam 32 will next be described. The motor gear 36 of the stepping motor 34 is engaged with a fourth gear 48 so as to transfer the rotation thereof, and the fourth gear 48 is engaged with a fifth gear 50 so as to transfer the rotation thereof. The fifth gear 50 is engaged with a contact and separation cam gear 52 so as to transfer the rotation thereof. The contact and separation cam gear 52 is coupled to a rotary shaft 32b of the contact and separation cam 32 through a second one-way clutch 54.

The second one-way clutch 54 (second driving power transfer means) is fixed to the rotary shaft 34b only when the motor gear 36 is rotated in the reverse direction to allow the contact and separation cam gear 52 and the rotary shaft 34b to integrally rotate in the direction of the broken-line arrow in FIG. 4, while it runs idle when the motor gear 36 is rotated in the normal direction, so that the rotation of the contact and separation cam gear 52 is not transferred to the rotary shaft 34b.

Next, operation of the present embodiment will be described. The stepping motor 34 is driven under the condition that the rotation direction thereof is switched to the reverse direction to the sheet feed direction and the drive speed thereof is set to the middle speed. Then, the motor gear 36 is rotated in the reverse direction to allow the rotation of the motor gear 36 to be transferred to the gears 48, 50, and 52, with the result that the rotation of the contact and separation cam gear 52 is transferred to the rotary shaft 32b through the second one-way clutch 54. Then, the contact and separation cam 32 is rotated to cause the leading end 32a thereof to be separated from the lower end portion 28a of the lever-like member 28, so that the lever-like member 28 swings to bring the secondary transfer roller 22 into contact with the transfer belt 16. Since the drive speed of the stepping motor 34 is set to middle speed at this time, the lever-like member 28 slowly swings. It follows that the secondary transfer roller 22 is brought into contact with the transfer belt 16 slowly, preventing damage due to impact resulting from contact between the secondary transfer roller 22 and the transfer belt 16.

A sheet supplied from a not-shown sheet supply section is fed along the sheet feed path 18. When reaching the resist roller 20 which is not driven, the sheet is stopped once, and the tilt thereof is corrected. After that, the drive speed of the stepping motor 34 is set to a speed that suits a printing condition and is driven in the normal direction. Then, the motor gear 36 is rotated in the normal direction, so that the rotation of the motor gear 36 is transferred to the first and second gears 38 and 40 and the first one-way clutch 42 fixes the second gear 40 and the third gear 44 to allow the rotation of the second gear 40 to be transferred to the third gear 44 to thereby cause the resist roller 20 to rotate. As a result, the sheet is fed toward the secondary transfer roller 22.

Since the motor gear 36 is rotated in the normal direction during this operation, the second one-way clutch 54 runs idle, so that a driving power of the stepping motor 34 is not transferred to the contact and separation cam 32.

Thereafter, a toner image on the transfer sheet 16 is transferred onto the sheet at once. As described above, only when the motor is rotated in the second direction opposite to the first direction, the second one-way clutch 54 transfers a driving power of the motor to the contact and separation mechanism in order to move the transfer roller between the first and second positions.

After the toner image has been transferred onto the sheet, the drive speed of the stepping motor 34 is switched to high speed to thereby rotate the contact and separation cam 32 at a high speed. Then, the leading end 32a of the contact and separation cam 32 is brought into contact with the lower end portion 28a of the lever-like member 28 at a high speed to allow the secondary transfer roller 22 to be quickly separated from the transfer belt 16, preventing unnecessary toner from being adhered to the secondary transfer roller 22. As described above, the contact and separation mechanism has a role of biasing the secondary transfer roller 22 by means of the spring 30 in the direction that the secondary transfer roller 22 is brought into contact with the transfer belt 16 and separating the secondary transfer roller 22 from the transfer belt 16 by means of the drive power transferred through the second one-way clutch 54.

Since the stepping motor 34 is rotated in the reverse direction during the toner image transfer process to the sheet, the first one-way clutch 42 runs idle, so that the driving power of the stepping motor 34 is not transferred to the resist roller 20.

The sheet discharged from the secondary transfer roller 22 is guided by the feed guide 24 and fed to the fixing unit 26, where the transferred image is fixed.

Although the drive speed of the stepping motor 34 can be switched between three levels and the speed values at the respective levels are set to the above values in the above embodiment, the number of speed levels and their values are not limited to the above, and they may appropriately be changed.

Further, it goes without saying that it is possible to obtain an image forming apparatus that includes a transfer roller contact and separation drive unit having the above configuration and a fixing unit that thermally fixes the toner image onto a sheet that has been subjected to an image transfer process by being pressed against the image carrier by means of the transfer roller.

Although the exemplary embodiment of the present invention has been shown and described, it will be apparent to those having ordinary skill in the art that a number of changes, modifications, or alternations to the invention as described herein may be made within the spirit of the present invention.

As has been described in detail, according to the present invention, a drive source can be shared between the sheet feed system and image forming system, eliminating the need to provide additional drive source, such as a case where a dedicated drive source needs to be provided. Thus, it is possible to prevent power consumption from being increased.

Further, by means of a drive means that can drive the gears in both the normal and reverse directions and a mechanical one-way clutch, it is possible to drive the contact and separation mechanism and sheet feed system or image forming system in an independent manner. This eliminates a gear train that has been used in a conventional configuration in which a drive means that drives gears in one direction is shared between the contact and separation mechanism and sheet feed system or image forming system, thereby reducing the number of mechanical parts.

Further, according to the present invention, a pulse-driven stepping motor is used as a drive means, so that it is possible to change the drive speed of a motor, thereby giving flexibility to the drive speed at the time of contact and separation operation.

Further, according to the present invention, the moving speed of the transfer roller is made lower when the transfer roller is brought into contact with the image carrier to prevent damage due to impact resulting from contact between the transfer roller and image carrier, while the moving speed of the transfer roller is made higher when the transfer roller is separated from the image carrier to allow the transfer roller to be quickly separated from the image carrier, preventing unnecessary toner from being adhered to the transfer roller.

What is claimed is:

1. A transfer roller contact and separation drive unit that moves a transfer roller for pressing a sheet against an image carrier carrying a toner image between a first position at which the transfer roller is brought into contact with the image carrier and a second position at which the transfer roller is separated from the image carrier, comprising:
a contact and separation mechanism that supports the transfer roller such that the transfer roller can move between the first and second positions;
a motor that can be rotated in both normal and reverse directions;
a first one-way clutch that transfers the driving power of the motor to a predetermined roller for performing sheet feed operation as a rotation driving power only when the motor is rotated in a first direction; and
a second one-way clutch that transfers the driving power of the motor to the contact and separation mechanism so as to move the transfer roller between the first and second positions only when the motor is rotated in a second direction opposite to the first direction.

2. The transfer roller contact and separation drive unit according to claim 1, comprising:
a motor controller that drives the motor such that the rotation speed at the time when the motor is rotated in the first direction and that at the time when the motor is rotated in the second direction differ from each other.

3. The transfer roller contact and separation drive unit according to claim 1, wherein
the contact and separation mechanism biases the transfer roller against the image carrier by means of an elastic member in the direction that the transfer roller is brought into contact with the image carrier as well as separates the transfer roller from the image carrier by means of a driving power transferred through the second one-way clutch.

4. The transfer roller contact and separation drive unit according to claim 1, wherein
the motor is a pulse-driven stepping motor.

5. The transfer roller contact and separation drive unit according to claim 1, wherein
the predetermined roller is a resist roller.

6. A transfer roller contact and separation drive unit that moves a transfer roller for pressing a sheet against an image carrier carrying a toner image between a first position at which the transfer roller is brought into contact with the image carrier and a second position at which the transfer roller is separated from the image carrier, comprising:
contact and separation means for supporting the transfer roller such that the transfer roller can move between the first and second positions;
a motor that can be rotated in both normal and reverse directions;
first driving power transfer means for transferring the driving power of the motor to a predetermined roller for performing sheet feed operation as a rotation driving power only when the motor is rotated in a first direction; and
second driving power transfer means for transferring the driving power of the motor to the contact and separation means so as to move the transfer roller between the first and second positions only when the motor is rotated in a second direction opposite to the first direction.

7. The transfer roller contact and separation drive unit according to claim 6, comprising:
motor control means for driving the motor such that the rotation speed at the time when the motor is rotated in the first direction and that at the time when the motor is rotated in the second direction differ from each other.

8. The transfer roller contact and separation drive unit according to claim 6, wherein
the contact and separation means biases the transfer roller against the image carrier by means of an elastic member in the direction that the transfer roller is brought into contact with the image carrier as well as separates the transfer roller from the image carrier by means of a driving power transferred through the second driving power transfer means.

9. The transfer roller contact and separation drive unit according to claim 6, wherein
the motor is a pulse-driven stepping motor.

10. The transfer roller contact and separation drive unit according to claim 6, wherein
the predetermined roller is a resist roller.

11. A transfer roller contact and separation drive method that moves a transfer roller for pressing a sheet against an image carrier carrying a toner image between a first position at which the transfer roller is brought into contact with the image carrier and a second position at which the transfer roller is separated from the image carrier, comprising:
transferring the driving power of the motor to a predetermined roller for performing sheet feed operation using a first one-way clutch as a rotation driving power only when the motor is rotated in a first direction; and
transferring the driving power of the motor to the contact and separation mechanism that supports the transfer roller such that the transfer roller can move between the first and second positions using a second one-way clutch so as to move the transfer roller between the first and second positions only when the motor is rotated in a second direction opposite to the first direction.

12. The transfer roller contact and separation drive method according to claim 11, comprising:
driving the motor such that the rotation speed at the time when the motor is rotated in the first direction and that at the time when the motor is rotated in the second direction differ from each other.

13. The transfer roller contact and separation drive method according to claim 11, wherein
the contact and separation mechanism biases the transfer roller against the image carrier by means of an elastic member in the direction that the transfer roller is brought into contact with the image carrier as well as separates the transfer roller from the image carrier by means of a driving power transferred through the second one-way clutch.

14. The transfer roller contact and separation drive method according to claim 11, wherein
the motor is a pulse-driven stepping motor.

15. The transfer roller contact and separation drive method according to claim 11, wherein
the predetermined roller is a resist roller.
